(19) United States
(12) Patent Application Publication
(10) Pub. No.: US 2022/0196995 A1
(43) Pub. Date: Jun. 23, 2022

(54) FULL-FRAME ANAMORPHIC LENS

(71) Applicant: ZHONGSHAN AZU OPTOELECTRONICS TECHNOLOGY CO., LTD., Zhongshan (CN)

(72) Inventors: Jie LI, Zhongshan (CN); Wei WU, Zhongshan (CN)

(73) Assignee: ZHONGSHAN AZU OPTOELECTRONICS TECHNOLOGY CO., LTD., Zhongshan (CN)

(21) Appl. No.: 17/561,710

(22) Filed: Dec. 24, 2021

Related U.S. Application Data
(63) Continuation of application No. PCT/IB2021/060526, filed on Nov. 12, 2021.

(30) Foreign Application Priority Data
Dec. 23, 2020 (CN) 202023162143.2

(51) Int. Cl. G02B 13/08; G02B 3/06; G02B 13/00

(52) U.S. Cl. CPC G02B 13/08; G02B 27/0025; G02B 13/0045; G02B 3/06

(57) ABSTRACT

A full-frame anamorphic lens includes an anamorphic lens group arranged in sequence from the object side to the image side and an imaging lens group composed of a plurality of spherical lenses. The special cylindrical lens combination of the anamorphic lens may result in the full-frame 1.6 distortion while effectively controlling the breathing effect and optical distortion, and making the lens optical structure more compact and portable. Use the lenses added before and after the double Gauss structure to correct asymmetric aberrations such as astigmatism, spherical aberration, curvature of field, and chromatic aberration. At the same time, the special optical characteristics of the first five cylindrical lenses of the optical structure are integrated with the ten spherical lenses behind the optical structure. The optical correction of the anamorphic lens enables the anamorphic lens to cover the full frame while achieving a large aperture of 2.8 and achieving 4K quality.

### CROSS-REFERENCE TO RELATED APPLICATION

This application claims priority to a Chinese patent application with an application number 202023162143.2, filed on Dec. 23, 2021. This application is also a continuation application of a PCT international application PCT/162021/060526, filed on Nov. 12, 2021. All these applications are incorporated by reference in their entirety herein.

### TECHNICAL FIELD

The present invention relates generally to the field of lens technology, and in particular, to a full-frame anamorphic lens.

### BACKGROUND

With the rapid development of web technology, taking photos and videos has become essential part for ordinary consumers. With the promotion of 5G and other technologies in recent years, more and more video sharing such as Vlog has been used. More individuals shoot short films and micro movies with mobile phones, cameras and other tools.

However, the mirrorless camera chip currently on the market has a ratio of 3:2, while the cinematic widescreen video ratio is 2.4:1. Therefore, users need to manually edit or digitally cropping method to edit the captured images or videos. However, the pixels of the pictures are sacrificed during cropping or editing. Some professional anamorphic lens brands such as, Hawk from Germany, Cooke from Great Britain, ARRI from Germany, Panavision from the USA, Angenieux from France and SLR from Hong Kong are usually tailored for professional customers. The prices of these film equipment are generally over tens of thousands of dollars or even more expensive, and anamorphic lenses themselves weighs several kilograms.

Expensive and quality professional anamorphic lenses are not suitable for ordinary users. Therefore, how to reduce the size of anamorphic lens and reducing the weight of the lens are technical problems that are to be solved by embodiments of the invention.

### SUMMARY

Therefore, embodiments of the invention attempt technically solve shortcomings in the existing art. In one example, embodiments of the invention provide a full-frame anamorphic lens that solves the issues with large volume with the exterior body, high cost, and breathing effect and optical distortion of traditional lenses.

In one embodiment, a full-frame anamorphic lens includes an anamorphic lens group arranged in sequence from the object side to the image side and an imaging lens group composed of a plurality of spherical lenses. In one embodiment, the anamorphic lens group includes a first lens, a second lens, a third lens, a fourth lens, and a fifth lens arranged in sequence from the object side to the image side; wherein the first lens may be a biconcave cylindrical lens with negative refractive power. The second lens may be a cylindrical lens with negative refractive power, the third lens may be a cylindrical lens with positive refractive power, the fourth lens may be a cylindrical lens with negative refractive power, the fifth lens may be a cylindrical lens with positive refractive power. The fourth and the fifth lens collectively and the first lens, the second lens, and the third lens are perpendicular to each other.

The full-frame anamorphic lens according to one embodiment of the first aspect of the present invention may include at least the following beneficial effects: the special cylindrical lens combination of the anamorphic lens can realize the full-frame 1.6 deformation while effectively controlling the breathing effect and optical distortion, and the optical structure of the lens is improved, while making the lens itself compact, small and portable. The optical solution of the full-frame anamorphic lens utilizes a classic double Gaussian structure for asymmetrical structure, thereby achieving partial cancellation of symmetrical aberrations, such as coma and distortion. Use the lenses added before and after the double Gauss structure to correct asymmetric aberrations such as astigmatism, spherical aberration, curvature of field, and chromatic aberration. At the same time, the special optical characteristics of the first five cylindrical lenses of the optical structure are integrated with the ten spherical lenses behind the optical structure. The optical correction of the anamorphic lens enables the anamorphic lens to cover the full frame while achieving a large aperture of 2.8 and achieving 4K quality. And use the optical characteristics of the cylindrical lens that constitutes the deformation group to “compress” the light entering horizontally, while the light entering the vertical direction remains unchanged, and then comprehensively correct the light through the subsequent imaging group, thereby making the lens horizontally shot The angle of view increases, so that the width of the actual shooting picture becomes larger. Aspects of the invention therefore no longer require the user to perform post-editing, and 2.4:1 widescreen video or photos may be obtained without sacrificing pixels. At the same time, because the anamorphic group is composed of cylindrical lenses, the anamorphic lens of this solution will have optical characteristics such as elliptical out-of-focus flare and sci-fi line flare in addition to the anamorphic function.

According to some embodiments of the present invention, the second lens and the third lens may form a cemented cylindrical lens.

According to some embodiments of the present invention, the imaging lens group may include a sixth lens, a seventh lens, an eighth lens, a diaphragm, a ninth lens, a tenth lens, and an eleventh lens, which may be sequentially arranged from the fifth lens to the image side. The lens, the twelfth lens, the thirteenth lens, the fourteenth lens, and the fifteenth lens, wherein the sixth lens may be a double convex spherical lens with positive refractive power, and the seventh lens may be a meniscus with positive refractive power. The eighth lens may be a negative refractive power spherical lens, the ninth lens may be a negative refractive power spherical lens, the tenth lens, the eleventh lens, the twelfth lens, and the thirteenth lens may be positive refractive power, the fourteenth lens may be a spherical lens with negative refractive power, and the fifteenth lens may be a negative meniscus lens.

According to some embodiments of the present invention, the ninth lens and the tenth lens may form a cemented spherical lens.

According to some embodiments of the present invention, the thirteenth lens and the fourteenth lens may constitute a cemented spherical lens.

According to some embodiments of the present invention, the power distribution of the lenses constituting the anamorphic lens group and the lenses constituting the imaging lens group may satisfy the following relationship:

45.0<fx(1-15)<55.0;

−4.50<fy(1-3)/fy(1-15)<−3.80;

−3.50<fx(4-5)/fy(1-15)<−2.50;

6.8<fy(6-8)/fy(9-15)<8.6;

−7.60<fy(1-3)/fy(4-15)<−5.60;

−5.00<fx(4-5)/fx(1-15)<−3.00;

Where, fx represents the focal length of the lens in the X direction, fy represents the focal length of the lens in the Y direction, where the number after fx/fy represents the lens number that constitutes the full-frame anamorphic lens, that is, fx(1) is the focal length of the first lens in the X direction. fx(1-15) is the combined focal length in the X direction of 15 lenses in total from the first lens to the fifteenth lens, and the rest is the same.

According to some embodiments of the present invention, the length of the full-frame anamorphic lens may be less than about 140 mm, and the maximum outer diameter of the full-frame anamorphic lens may be less than about 85 mm.

According to some embodiments of the present invention, the Y-direction focal length of the full-frame anamorphic lens may be about 50 mm, and the aperture may be about 2.8.

The additional aspects and advantages of the present invention will be partially given in the following description, and some will become apparent from the following description, or be understood through the practice of the present invention.

### BRIEF DESCRIPTION OF DRAWINGS

In order to more clearly illustrate the specific embodiments of the present invention or the technical solutions in the prior art, the drawings needed to be used in embodiments or the description of the prior art are briefly introduced below. Obviously, the drawings in the following are some embodiments of the present invention. For those of ordinary skill in the art, other drawings may be obtained based on these drawings without undue creative labor.

FIG. 1 is a Y-direction optical structure diagram of an embodiment of the present invention;

FIG. 2 is an X-direction optical structure diagram of an embodiment of the present invention;

FIG. 3 is a field curvature and distortion diagram of an embodiment of the present invention;

FIG. 4 is a transfer function diagram of an embodiment of the present invention;

FIG. 5 is a chromatic aberration diagram of magnification according to an embodiment of the present invention;

FIG. 6 is a relative contrast diagram of an embodiment of the present invention.

The following lists the labels for the reference numbers:

Anamorphic lens group 100, first lens 101, second lens 102, third lens 103, fourth lens 104, and fifth lens 105; imaging lens group 200, sixth lens 206, seventh lens 207, eighth lens 208, diaphragm, ninth lens 209, tenth lens 210, eleventh lens 211, twelfth lens 212, and thirteenth lens 213 , Fourteenth lens 214, fifteenth lens 215.

### DETAILED DESCRIPTION

The technical solution of the present invention may be clearly and completely described below with reference to the accompanying drawings. Obviously, the described embodiments may be part of the present invention, but not all of them. Based on the embodiments of the present invention, all other embodiments obtained by a person of ordinary skill in the art without creative efforts shall fall within the protection scope of the present invention.

In the description of the present invention, it is noted that the terms “center”, “up”, “down”, “left”, “right”, “vertical”, “horizontal”, “inside”, “outside”, etc., are meant to indicate orientation or positional relationship and they may be based on the orientation or positional relationship shown in the drawings, and may only be for the convenience of describing the present invention and simplified description, and does not indicate or imply that the device or element referred to must have a specific orientation, a specific construction and operation as they are not be construed as limiting the invention. In addition, the terms “first,” “second,” and “third” may be used for descriptive purposes only, and should not be construed to indicate or imply relative importance.

In the description of embodiments of the present invention, it is noted that the terms “installation”, “connected”, and “connected” should be understood in a broad sense unless otherwise specified and limited. For example, they may be fixed connections or removable, connected or integrated; it may be mechanical or electrical; it may be directly connected, or it may be indirectly connected through an intermediate medium, or it may be the internal communication of two elements. For those of ordinary skill in the art, the specific meanings of the above terms of embodiments of the present invention may be understood in a case-by-case basis.

In addition, the technical features involved in the different embodiments of the present invention described below may be combined with each other as long as they do not conflict with each other.

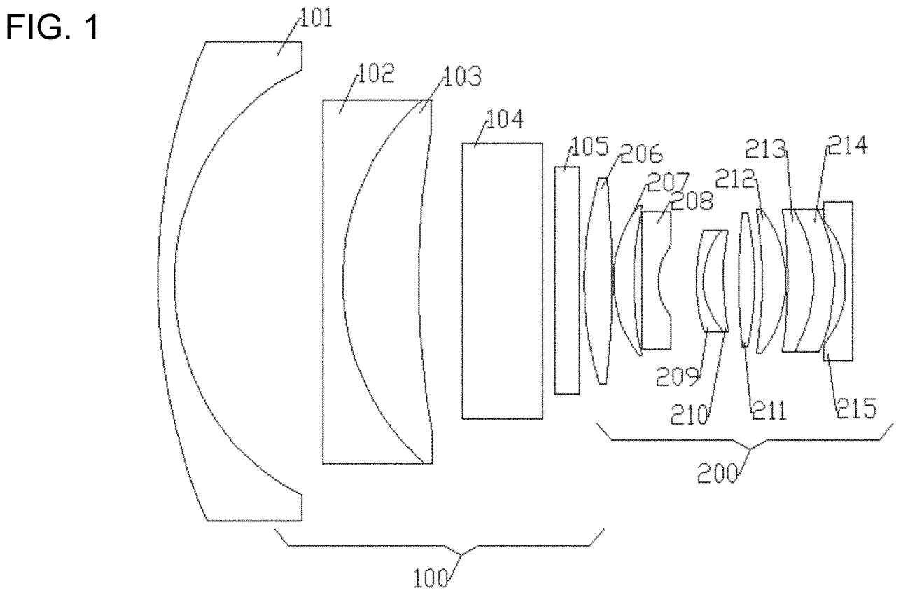

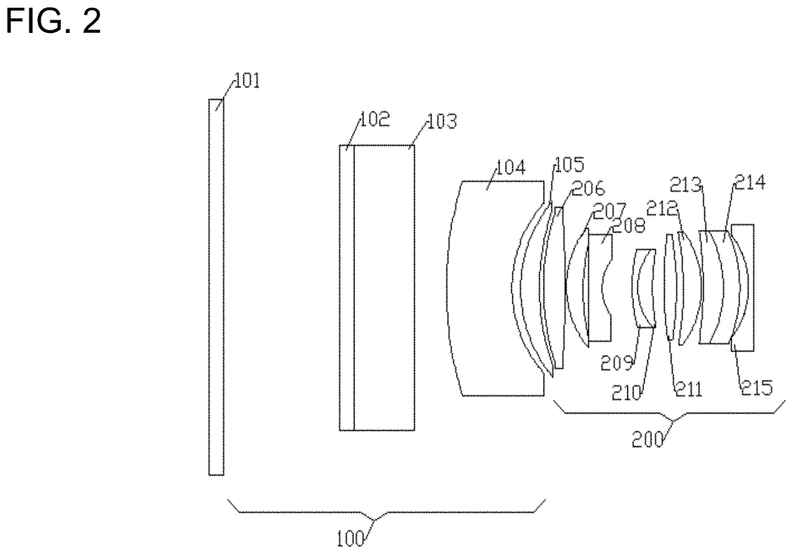

Referring to FIGS. 1 and 2, a full-frame anamorphic lens according to an embodiment of the present invention according to the technical solution includes an anamorphic lens group 100 and an imaging lens group composed of a plurality of spherical lenses sequentially arranged from the object side to the image side 200; The anamorphic lens group 100 includes a first lens 101, a second lens 102, a third lens 103, a fourth lens 104, and a fifth lens 105 that are sequentially arranged from the object side to the image side; wherein, the first lens 101 is A double-concave cylindrical lens with negative refractive power, the second lens 102 is a cylindrical lens with negative refractive power, the third lens 103 is a cylindrical lens with positive refractive power, the fourth lens 104 is a cylindrical lens with negative refractive power, and the fifth lens The lens 105 is a cylindrical lens with positive refractive power, and the generatrices of the fourth lens 104 and the fifth lens 105 and the first lens 101, the second lens 102 and the third lens 103 are perpendicular to each other.

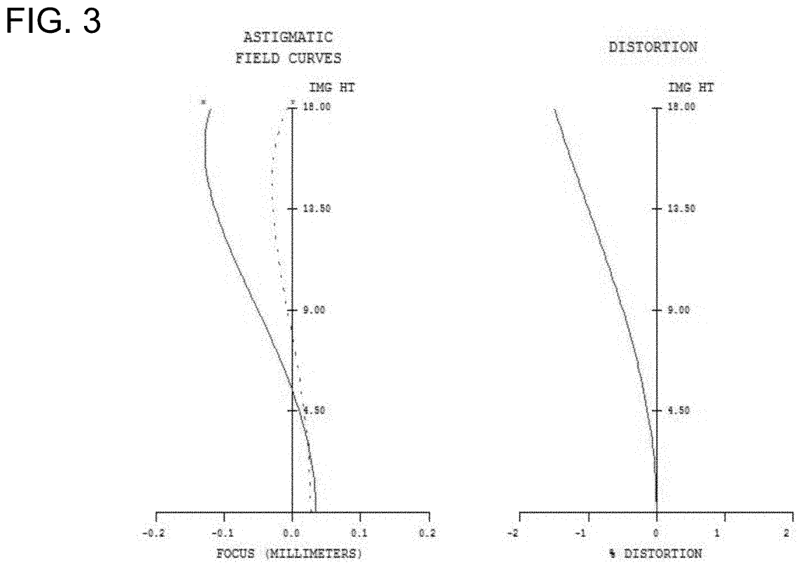

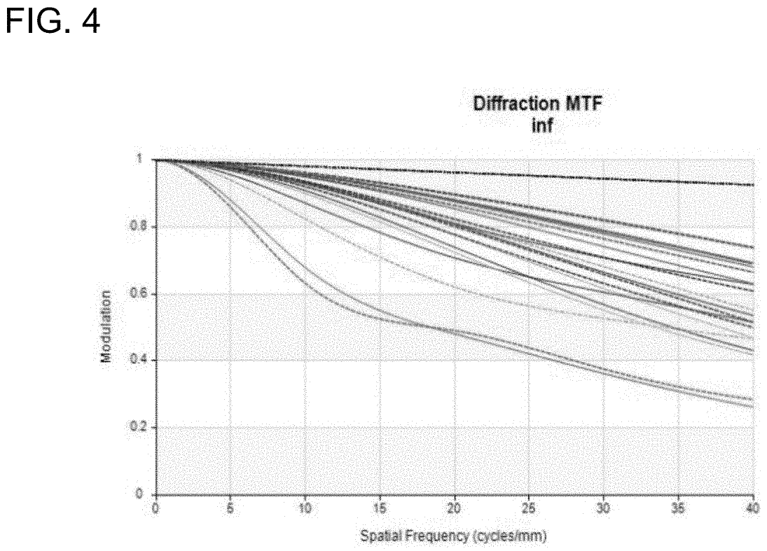

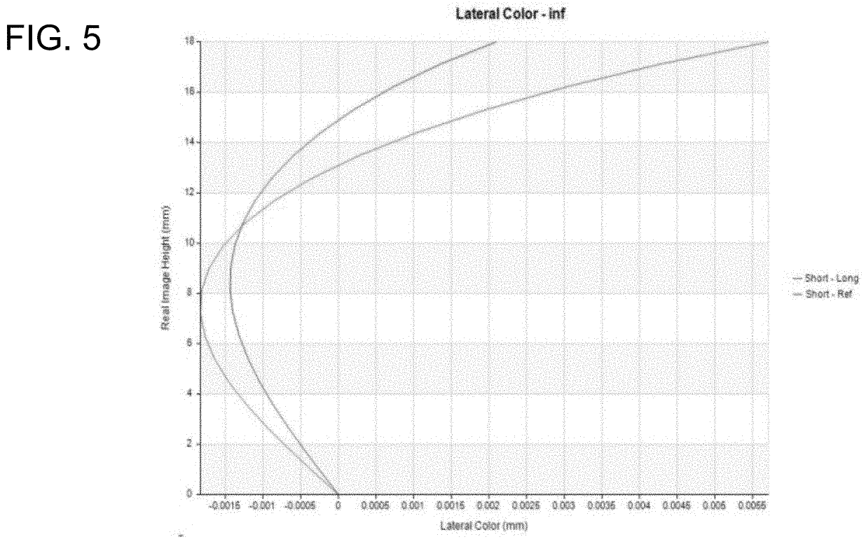

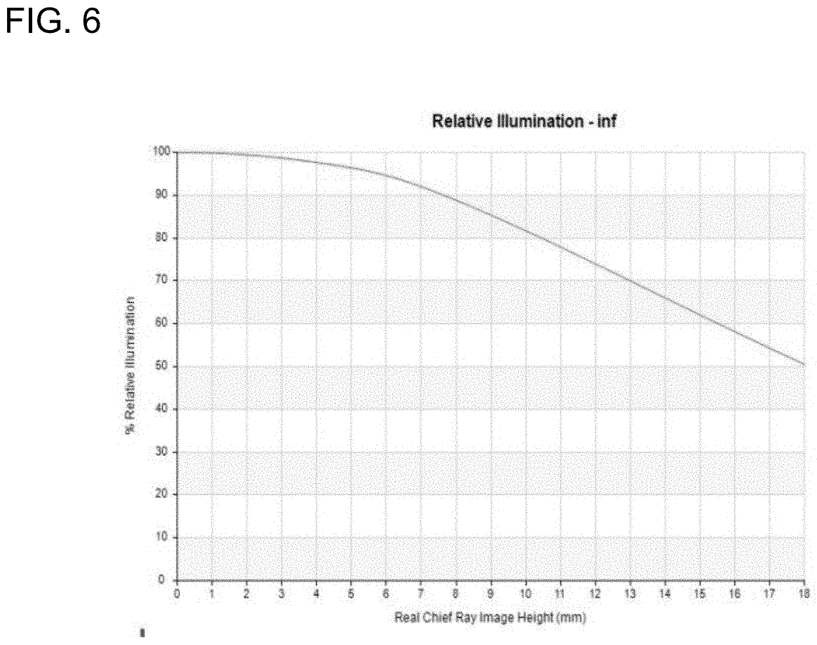

As shown in FIGS. 3 to 6, based on the above structure, this technical solution can achieve a full-frame 1.6 deformation through a special cylindrical lens combination while effectively controlling the breathing effect and optical distortion, and making the lens optical structure more compact. The optical solution of the full-frame anamorphic lens utilizes a classic double Gaussian structure for asymmetrical structure, thereby achieving partial cancellation of symmetrical aberrations, such as coma and distortion. Use the lenses added before and after the double Gauss structure to correct asymmetric aberrations such as astigmatism, spherical aberration, curvature of field, and chromatic aberration. At the same time, the special optical characteristics of the first five cylindrical lenses of the optical structure are integrated with the ten spherical lenses behind the optical structure. The optical correction of the anamorphic lens enables the anamorphic lens to cover the full frame while achieving a large aperture of 2.8 and achieving 4K quality. And use the optical characteristics of the cylindrical lens that constitutes the deformation group to “compress” the light entering horizontally, while the light entering the vertical direction remains unchanged, and then comprehensively correct the light through the subsequent imaging group, thereby making the lens horizontally shot The angle of view increases, so that the width of the actual shooting picture becomes larger. No need for post-editing from the user, and 2.4:1 widescreen video or photos can be obtained without sacrificing pixels. At the same time, because the anamorphic group is composed of cylindrical lenses, the anamorphic lens of this solution will have optical characteristics such as elliptical out-of-focus flare and sci-fi line flare in addition to the anamorphic function.

In some embodiments of the present invention, the imaging lens group 200 includes a sixth lens 206, a seventh lens 207, an eighth lens 208, a diaphragm, a ninth lens 209, and the tenth lens 210, the eleventh lens 211, the twelfth lens 212, the thirteenth lens 213, the fourteenth lens 214, and the fifteenth lens 215, wherein the sixth lens 206 is a double convex spherical surface with positive refractive power The seventh lens 207 is a meniscus spherical lens with positive refractive power, the eighth lens 208 is a spherical lens with negative refractive power, and the ninth lens 209 is a spherical lens with negative refractive power. The lens 210, the eleventh lens 211, the twelfth lens 212, and the thirteenth lens 213 are positive refractive power spherical lenses, the fourteenth lens 214 is a negative refractive power spherical lens, and the fifteenth lens 215 is meniscus negative lens.

In some embodiments of the present invention, the second lens 102 and the third lens 103 form a cemented cylindrical lens.

In some embodiments of the present invention, the ninth lens 209 and the tenth lens 210 constitute a cemented spherical lens.

In some embodiments of the present invention, the thirteenth lens 213 and the fourteenth lens 214 constitute a cemented spherical lens.

The above-mentioned three groups of glued structures are combined by bonding. As an alternative embodiment, based on the concept of the present invention, in order to distinguish it from the present application, the above-mentioned combination method is changed, such as lamination, integral molding, etc., and then the combined lens shape is adaptively changed, Should also be included in the scope of protection of this application.

For a single lens or two consecutive lenses with the same sign of power, a single lens can be split into two or more lenses, and two consecutive lenses with the same sign can be combined into one lens, such as the optical structure of the patent Simple transformations, such as the distribution of the optical power of the transformed lens or lens group, are within the scope of the patent mathematical relationship expression. On the basis of this embodiment, changes and replacements to the number and combination of lenses in order to distinguish them from this application are all within the scope of protection of this application without departing from the main idea of this application.

In some embodiments of the present invention, the power distribution of the lenses constituting the anamorphic lens group 100 and the lenses constituting the imaging lens group 200 satisfy the following relationship:

45.0<fx(1-15)<55.0;

−4.50<fy(1-3)/fy(1-15)<−3.80;

−3.50<fx(4-5)/fy(1-15)<−2.50;

6.8<fy(6-8)/fy(9-15)<8.6;

−7.60<fy(1-3)/fy(4-15)<−5.60;

−5.00<fx(4-5)/fx(1-15)<−3.00;

Where, fx represents the focal length of the lens in the X direction, fy represents the focal length of the lens in the Y direction, where the number after fx/fy represents the lens number that constitutes the full-frame anamorphic lens, that is, fx(1) is the focal length of the first lens in the X direction. fx(1-15) is the combined focal length in the X direction of 15 lenses in total from the first lens to the fifteenth lens, and the rest is the same.

The following lists the actual parameters of each lens of this embodiment that comply with the above mathematical relationship:

| | | | | | Refractive | Abbe |
|---|---|---|---|---|---|---|
| Lens | Surface shape | X radius (mm) | Y radius (mm) | Thickness (mm) | index | Number |
| first | cylindrical | inf | 95.410 | 3.49 | 1.804 | 46.59 |
| | cylindrical | inf | 40.245 | 28.600 | | |
| second | cylindrical | inf | −1800 | 3.44 | 1.518 | 52.00 |
| third | cylindrical | inf | 39.100 | 14.80 | 1.831 | 28.53 |
| | cylindrical | inf | 150.000 | 8.10 | | |
| fourth | cylindrical | 74.960 | inf | 15.87 | 1.927 | 24.32 |
| | cylindrical | 26.480 | inf | 2.120 | | |
| fifth | cylindrical | 27.540 | inf | 4.64 | 1.946 | 17.94 |
| | cylindrical | 47.320 | inf | 1.035 | | |
| sixth | spherical | 52.830 | 52.830 | 5.40 | 1.696 | 55.54 |
| | spherical | −169.430 | −169.430 | 0.250 | | |
| seventh | spherical | 19.270 | 19.270 | 4.10 | 1.911 | 35.13 |
| | spherical | 44.350 | 44.350 | 1.130 | | |
| eighth | spherical | 164.640 | 164.640 | 3.80 | 1.746 | 74.57 |
| | spherical | 11.190 | 11.190 | 5.532 | | |
| Diaphragm | | | | | | |
| ninth | spherical | 28.585 | 28.585 | 1.30 | 1.869 | 24.66 |
| tenth | spherical | 11.580 | 11.580 | 3.70 | 1.774 | 48.55 |
| | spherical | 38.030 | 38.030 | 3.150 | | |
| eleventh | spherical | 92.310 | 92.310 | 2.900 | 1.944 | 17.98 |
| | spherical | −53.200 | −53.200 | 1.570 | | |
| twelfth | spherical | −71.880 | −71.880 | 4.55 | 1.654 | 57.38 |
| | spherical | −18.370 | −18.370 | 0.200 | | |
| thirteenth | spherical | −113.150 | −113.150 | 5.02 | 1.560 | 63.13 |
| fourteenth | spherical | −22.910 | −22.910 | 4.10 | 1.551 | 41.42 |
| | spherical | −31.290 | −31.290 | 2.040 | | |
| fifteenth | spherical | −17.760 | −17.760 | 1.30 | 1.890 | 36.81 |
| | spherical | inf | inf | | | |

In some embodiments of the present invention, the length of the full-frame anamorphic lens is less than 140 mm, and the maximum outer diameter of the full-frame anamorphic lens is less than 85 mm.

In some embodiments of the present invention, the Y-direction focal length of the full-frame anamorphic lens is 50 mm, and the aperture is 2.8.

Before adopting the anamorphic lens of this embodiment, the field of view angle of a lens with a focal length of 50 mm and an aperture of 2.8 is: V (vertical) 26.14° and H (horizontal) 38.31°.

After using the anamorphic lens of this embodiment, the field of view angle of the lens with a focal length of 50 mm and an aperture of 2.8 is: V (vertical) 26.14° , H (horizontal) 62.30°.

The angle of the field of view in the comparison test is unchanged in the vertical direction, and the ratio of the angle of the field of view in the horizontal direction is 62.30/38.31=1.626.

The actual width ratio is in the range of 2.35-2.40, so the deformation ratio is 1.60, that is, the horizontal field of view angle is increased by 60%, thereby realizing 1.60× deformation shooting.

During the production of the anamorphic lens of this embodiment, the length of the anamorphic lens itself is less than 140 mm, the maximum outer diameter is less than 85 mm, and the mass is less than 900g, which is much smaller than the photographic camera interchangeable lens of the same specification, and at the same time much smaller than the professional movie of the same specification on the market. Anamorphic lens.

Among them, there is no specific limitation on the material for each lens. In this embodiment, each lens is made of optical glass.

The lens of the present application can be designed to be compatible with the bayonet of cameras of various brands on the market according to actual use requirements, so as to achieve personalized customization and universal coordination.

In the description of this specification, the description with reference to the terms “one embodiment”, “some embodiments”, “exemplary embodiments”, “examples”, “specific examples”, or “some examples” etc. means to incorporate the implementation The specific features, structures, materials, or characteristics described by the examples or examples are included in at least one embodiment or example of the present invention. In this specification, the schematic representations of the above-mentioned terms do not necessarily refer to the same embodiment or example. Moreover, the described specific features, structures, materials or characteristics can be combined in any one or more embodiments or examples in a suitable manner.

Obviously, the foregoing embodiments may merely be an example with clear description and not as a limitation. For those of ordinary skill in the art, other different forms of changes or modifications may be made on the basis of the above description. There is no need and cannot be exhaustive to illustrate all implementations. However, the obvious changes or variations introduced thereby are still within the protection scope created by the present invention.

What is claimed is:

1. A full-frame anamorphic lens comprising:
an anamorphic lens group (100) arranged in sequence from the object side to the image side and an imaging lens group (200) composed of a plurality of spherical lenses;
wherein the anamorphic lens group (100) comprises a first lens (101), a second lens (102), a third lens (103), a fourth lens (104), and a fifth lens (105);
wherein the first lens (101) is a negative refractive power biconcave cylindrical lens, the second lens (102) is a negative refractive power cylindrical lens, and the third lens (103) is a positive refractive power cylindrical lens, the fourth lens (104) is a cylindrical lens with negative refractive power, the fifth lens (105) is a cylindrical lens with positive refractive power, and the fourth lens (104) and the fifth lens (105) are connected to the first lens;
wherein the generatrices of first lens (101), the second lens (102), and the third lens (103) are perpendicular to each other.

2. The full-frame anamorphic lens according to claim 1, wherein the second lens (102) and the third lens (103) form a cemented cylindrical lens.

3. The full-frame anamorphic lens according to claim 1, wherein the imaging lens group (200) comprises a sixth lens (206) and a seventh lens arranged in sequence from the fifth lens (105) to the image side (207), eighth lens (208), diaphragm, ninth lens (209), tenth lens (210), eleventh lens (211), twelfth lens (212), thirteenth lens (213)), the fourteenth lens (214), and the fifteenth lens (215), wherein the sixth lens (206) is a double convex spherical lens with positive refractive power, and the seventh lens (207) is a meniscus with a positive refractive power, the eighth lens (208) is a negative refractive power spherical lens, the ninth lens (209) is a negative refractive power spherical lens, the tenth lens (210), the eleventh lens (211), the twelfth lens (212), and the thirteenth lens (213) are spherical lenses with positive refractive power, the fourteenth lens (214) is a spherical lens with negative refractive power, and the fifteenth lens (215) is a negative meniscus lens.

4. The full-frame anamorphic lens according to claim 3, wherein the ninth lens (209) and the tenth lens (210) form a cemented spherical lens.

5. The full-frame anamorphic lens according to claim 3, wherein the thirteenth lens (213) and the fourteenth lens (214) form a cemented spherical lens.

6. The full-frame anamorphic lens according to claim 3, wherein the refractive power distribution of the lenses constituting the anamorphic lens group (100) and the lenses constituting the imaging lens group (200) satisfies the following relationship:
45.0<fx(1-15)<55.0;
−4.50<fy(1-3)/fy(1-15)<−3.80;
−3.50<fx(4-5)/fy(1-15)<−2.50;
6.8<fy(6-8)/fy(9-15)<8.6;
−7.60<fy(1-3)/fy(4-15)<−5.60;
−5.00<fx(4-5)/fx(1-15)<−3.00;
wherein, fx represents the focal length of the lens in the X direction, fy represents the focal length of the lens in the Y direction, where the number after fx/fy represents the lens number that constitutes a full-frame anamorphic lens, that is, fx (1) is the first lens (101) in the X direction Fx (1-15) is the combined focal length of 15 lenses in the X direction of the first lens (101) to the fifteenth lens (215), and the rest is the same.

7. The full-frame anamorphic lens according to claim 1, wherein the length of the full-frame anamorphic lens is less than 140 mm, and the maximum outer diameter of the full-frame anamorphic lens is less than 85 mm.

8. The full-frame anamorphic lens according to claim 6, wherein the Y-direction focal length of the full-frame anamorphic lens is 50 mm, and the aperture is 2.8.

9. The full-frame anamorphic lens according to claim 2, wherein the length of the full-frame anamorphic lens is less than 140 mm, and the maximum outer diameter of the full-frame anamorphic lens is less than 85 mm.
